(19) United States
(12) Patent Application Publication
(10) Pub. No.: US 2016/0314261 A1
(43) Pub. Date: Oct. 27, 2016

(54) SYSTEM AND METHOD FOR COORDINATING ON-DEMAND MEDICAL SERVICES

(71) Applicant: Mend VIP, Inc., Orlando, FL (US)

(72) Inventor: Matthew D. MCBRIDE, Orlando, FL (US)

(73) Assignee: MEND VIP, INC., Orlando, FL (US)

(21) Appl. No.: 14/696,033

(22) Filed: Apr. 24, 2015

(51) Int. Cl. G06F 19/00; G06Q 50/22

(52) U.S. Cl. CPC G06F 19/3418; G06Q 50/22

(57) ABSTRACT

A system and method for coordinating on-demand medical services. The method can include executing on one or more processors the steps of determining, from a pool of service providers, a plurality of service providers within a geographical proximity of a patient, determining service provision time for one or more service types, for each service provider of the plurality of service providers, causing to be displayed, on a computing device of the patient, the plurality of service providers, one or more service types for each service provider, service provision times for each service type, and costs for each service type, receiving a service provider selection and a service type selection from the patient, and facilitating a connection between the patient and the selected service provider.

### BACKGROUND

Traditional solutions for provision of medical services are typically cumbersome and time consuming. Such solutions usually involve a patient calling a doctor's or other medical service provider's office, and setting an appointment with the office for a future time and date. The patient then has to travel to the office so as to arrive at the time of appointment, and is frequently required to wait past the appointment time to be seen by the doctor and medical provider. A streamlined, efficient solution for provision of medical services is therefore desired.

### SUMMARY

According to at least one exemplary embodiment, a method for coordinating on-demand medical services is disclosed. The method can include executing on one or more processors the steps of determining, from a pool of service providers, a plurality of service providers within a geographical proximity of a patient, determining service provision time for one or more service types, for each service provider of the plurality of service providers, causing to be displayed, on a computing device of the patient, the plurality of service providers, one or more service types for each service provider, service provision times for each service type, and costs for each service type, receiving a service provider selection and a service type selection from the patient, and facilitating a connection between the patient and the selected service provider.

According to another exemplary embodiment, computer readable instructions are disclosed for causing a computing device of a patient to perform the steps of sending a geographical location of the computing device, displaying, on a display of the computing device, a plurality of service providers within geographical proximity to the location of the computing device, one or more service types for each service provider, service provision times for each service type, and costs for each service type, sending a service provider selection and a service type selection, and displaying, on the display of the computing device, a live monitoring interface, the live monitoring interface including one or more of wait time, delay time, progress communications, and location of the selected service provider.

According to another exemplary embodiment, computer readable instructions are disclosed for performing the steps of determining, from a pool of service providers, a plurality of service providers within a geographical proximity of a patient, determining service provision time for one or more service types, for each service provider of the plurality of service providers, causing to be displayed, on a computing device of the patient, the plurality of service providers, one or more service types for each service provider, service provision times for each service type, and costs for each service type, receiving a service provider selection and a service type selection from the patient, and facilitating a connection between the patient and the selected service provider.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1A shows an exemplary computing device upon which embodiments of the present invention may be implemented.

FIG. 1B shows an exemplary system upon which embodiments of the present invention may be implemented

FIG. 2 shows an exemplary system for coordinating on-demand medical services.

FIG. 3 shows an exemplary method for registering a patient account with a system for coordinating on-demand medical services.

FIG. 4 shows an exemplary method for registering a service provider account with a system for coordinating on-demand medical services.

FIG. 5 shows an exemplary primary user interface for a patient on-demand service application.

FIG. 6 shows an exemplary service provider display interface for a patient on-demand service application.

FIG. 7A shows an exemplary confirmation interface for a patient on-demand service application.

FIG. 7B shows an exemplary patient selection interface for a patient on-demand service application.

FIG. 8 shows an exemplary live monitoring interface for a patient on-demand service application.

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

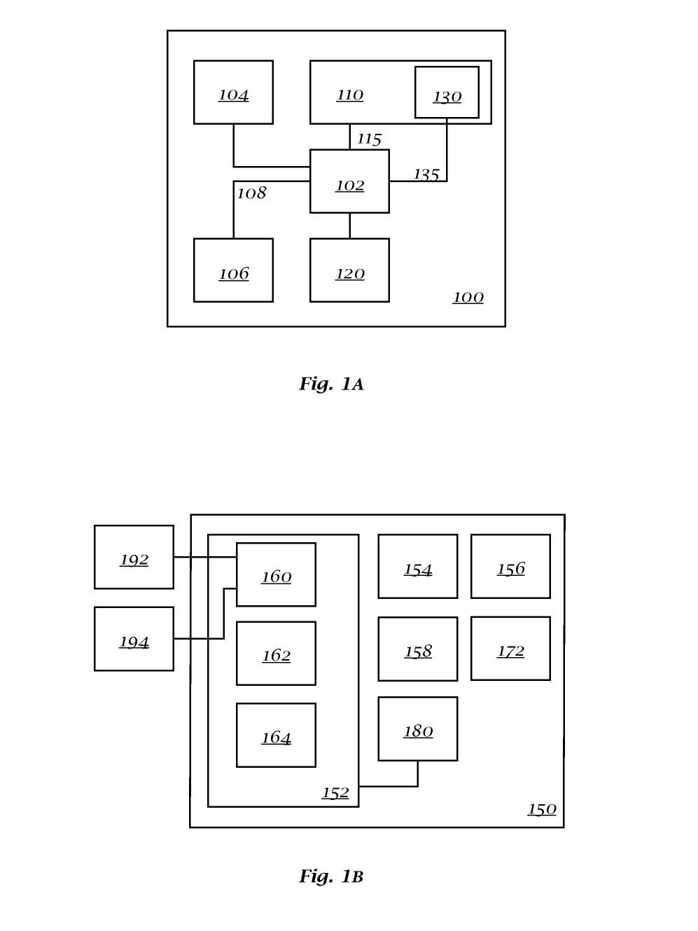

FIG. 1a is a block diagram that illustrates a mobile computing device upon which embodiments described herein may be implemented. In one embodiment, a computing device 100 may correspond to a mobile computing device, such as a cellular device that is capable of telephony, messaging, and data services. Examples of such devices may include smartphones, handsets or tablet devices for cellular carriers. Computing device 100 includes a processor 102, memory resources 104, a display device 106 (for example a touch-sensitive display device), one or more communication sub-systems 110 (including wireless communication sub-systems), input mechanisms 120 (for example an input mechanism can include or be part of the touch-sensitive display device), and one or more location detection mechanisms (for example a GPS component) 130. In one example, at least one of the communication sub-systems 110 may send and receive cellular data over data channels and voice channels.

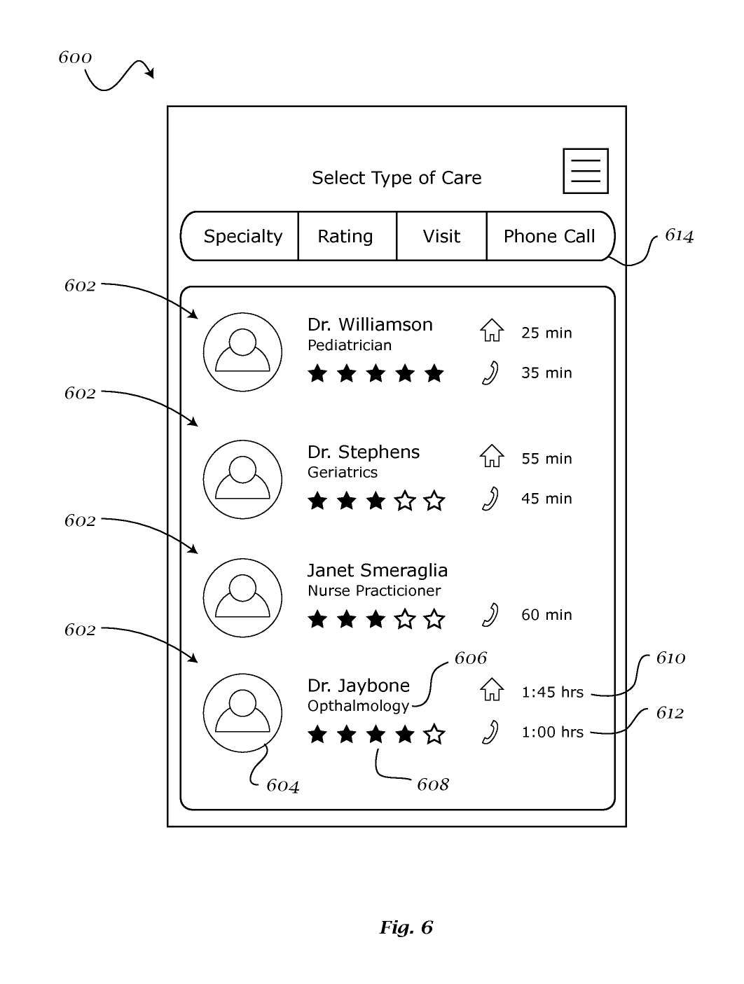

The processor 102 may be configured with software and/or other logic to perform one or more processes, steps and other functions described with implementations, such as described herein, and elsewhere in the application. Processor 102 may be configured with instructions and data stored in the memory resources 104, to operate an on-demand service application as described herein. For example, instructions for operating the service application to display various user interfaces, such as described in FIGS. 5-8, can be stored in the memory resources 104 of the computing device 100. In one implementation, a user can operate the on-demand service application so that location data 135 can be received by the GPS component 130. The location data 135 can be used by the application to present user interface features that are made specific to the current location of the computing device 100.

The location data 135 can also be provided to the on-demand service system using the communication sub-systems 110. The communication sub-systems 110 can enable the computing device 100 to communicate with other servers and computing devices, for example, over a network (e.g., wirelessly or using a wireline). The location data 135 can be communicated to the on-demand service system so that when the user requests the on-demand service, the system can arrange the service between the user and an available service provider. The communication sub-systems 110 can also receive provider information 115 (such as location and/or movement information of medical providers in real-time) from the on-demand service system and transmit the provider information 115 to the processor 102 for displaying provider data on one or more user interfaces 108.

The processor 102 can cause user interface features to be presented on the display 106 by executing instructions and/or applications that are stored in the memory resources 104. In some examples, user interfaces 108, such as user interfaces described with respect to FIGS. 5-8, can be provided by the processor 102 based on user input and/or selections received from the user. In some implementations, the user can interact with the touch-sensitive display 106 to make selections on the different user interface features 108 so that region-specific information (that is based on the user selections) can be provided with the user interface features 108. While FIG. 1 is illustrated for a mobile computing device, one or more embodiments may be implemented on other types of devices, including full-functional computers, such as laptops and desktops.

FIG. 1b shows an exemplary embodiment of a system 150 for coordinating on-demand medical services. System 150 may be implemented on a special purpose computing system, and may include processor-executable instructions 170 for implementing the functionality described herein, as well as any other desired instructions. System 150 may further include one or more data stores 172 for storing data related to the functionality described herein, for example patient and service provider data, as well as any other desired data. Some or all of the components of system 150 may be implemented on one or more computing devices, such as on one or more servers, or other computing devices. Accordingly, system 150 can use data provided by an on-demand service system, data provided by other components of the mobile computing device, and information provided by a user in order to present user interface features and functionality for enabling the user to request an on-demand service. The user interface features can be specific to the location or region that the computing device is located in, so that region-specific information can be provided to the user. System 150 can also adjust the user interface features, including the content displayed as part of the user interface features, based on other user selections.

In some implementations, system 150 includes an on-demand service application 152, a map component 154, a map database 156, and a location determination 158. The components of system 150 can combine to provide user interface features that are specific to user selections, user locality, and/or real-time conditions to enable a user to request on-demand services. The on-demand service application 152 can correspond to a program that is downloaded onto a smartphone, portable computer device (e.g., tablet or other geo-aware device). In one implementation, a user can download and install the on-demand service application 152 on his or her computing device and register the computing device 100 with an on-demand service system 180. The on-demand service system 180 can coordinate provision of medical services between patients and service providers.

The on-demand service application 152 can include an application manager 160, a user interface (UI) component 162, and a service interface 164. The service interface 164 can be used to handle communications exchanged between the on-demand service application 152 and the on-demand service system 180 (e.g., over a network). For example, the service interface 164 can use one or more network resources of the device 100 for exchanging communications over a wireless network. The network resources can include, for example, a cellular data/voice interface to enable the device to receive and send network communications over a cellular transport. As an alternative or variation, the network resources can include a wireless network interface for connecting to access points (e.g., 802.11) or for using other types of wireless mediums.

The application manager 160 can receive user input 192, location information 194, and other information to configure content that is to be provided by the UI component 162. For example, the UI component 162 can cause various user interface features to be output to a display of the computing device 100. Some of the user interface features can be based on the current location of the computing device to display information that is particular to the area surrounding the location of the computing device. The user interface features can also provide dynamically adjusted content based on user selections provided via the user input 192.

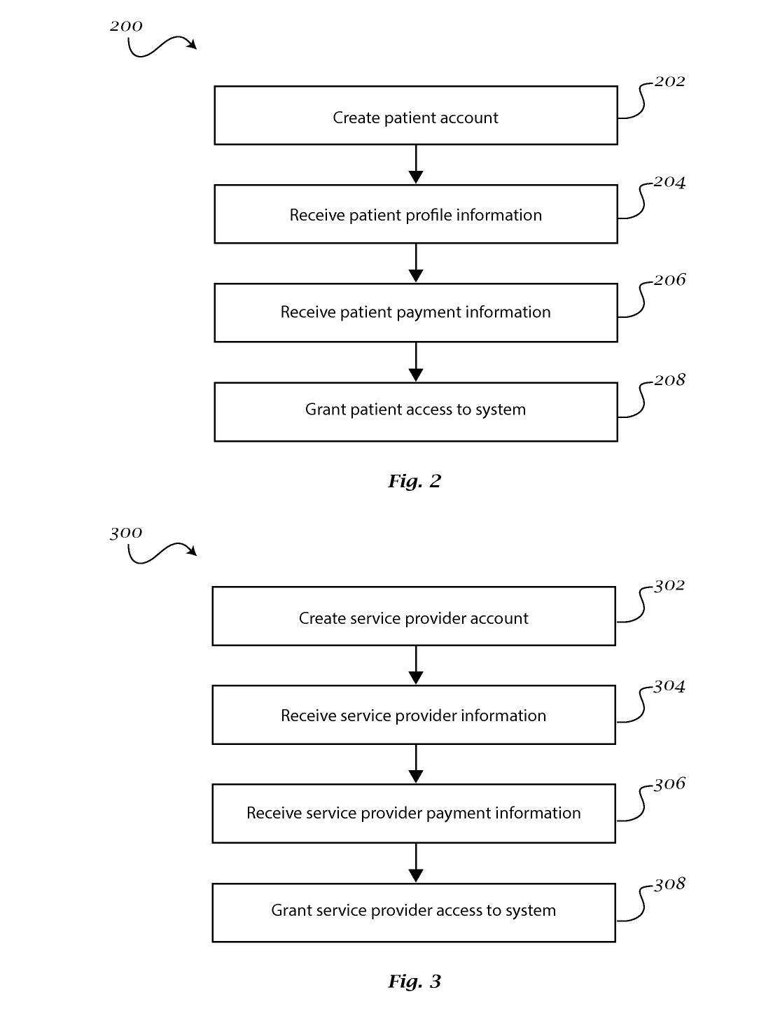

The above-described exemplary system and device may be utilized to implement, execute and provide the methods and interfaces further described herein. FIG. 2 shows an exemplary embodiment of a method 200 for registering a patient account and creating a user profile. A user may enter registering information in a user interface provided by service application 152. At step 202 a patient user account may be created. The patient user may create a patient account by, for example, registering a user name and password. The user name may be one or more of an email, telephone number, or other information unique to the patient. The password may be created in conjunction with the user name, and provide access the user account. Once registered, a patient may sign into the system using the user name and password.

Subsequently, at step 204, patient profile information may be received and associated with the patient account created at step 202. Reception of patient profile information may be facilitated by a user interface provided by service application 152. The patient profile information may include information such as the patient's first name, last name, date of birth, and gender. The patient profile information may further include a personal photograph, which may be obtained via a camera of the computing device, or by uploading an existing photograph, for example, from the memory of the computing device. Additional patient information may also be included in the patient profile, such as insurance plan information, medical history, employment information, emergency contacts, medications, allergies, immunizations, lifestyle, tests and surgeries, demographic information or any other information as would be understood by a person of ordinary skill in the art. In some embodiments, one or more additional patient profiles may be associated with a single patient account. For example, patient profiles for a user's spouse, child, or other dependent may also be associated with the patient account by repeating step 204 with the additional patient information.

In some exemplary embodiments, a patient may view patient profile information at any time. Patient profile information may be continuously updated in real-time, whether or not a patient is actively pursuing on-demand medical services. For example, the patient profile information may display real time information related to insurance plan information such as the patient's current personal and/or family deductible, co-pay, explanation of benefits, out of pocket maximum, or other real time healthcare information as would be understood by a person of ordinary skill in the art.

At step 206, payment information may be received and associated with the account. The user may provide payment information, for example via a user interface provided by service application 152. At step 208, the patient profiles associated with the user account may be permitted to access the methods for providing on-demand medical services of system 150. To facilitate accessing such methods, a primary user interface, such as illustrated in FIG. 5 may be displayed on the user's computing device.

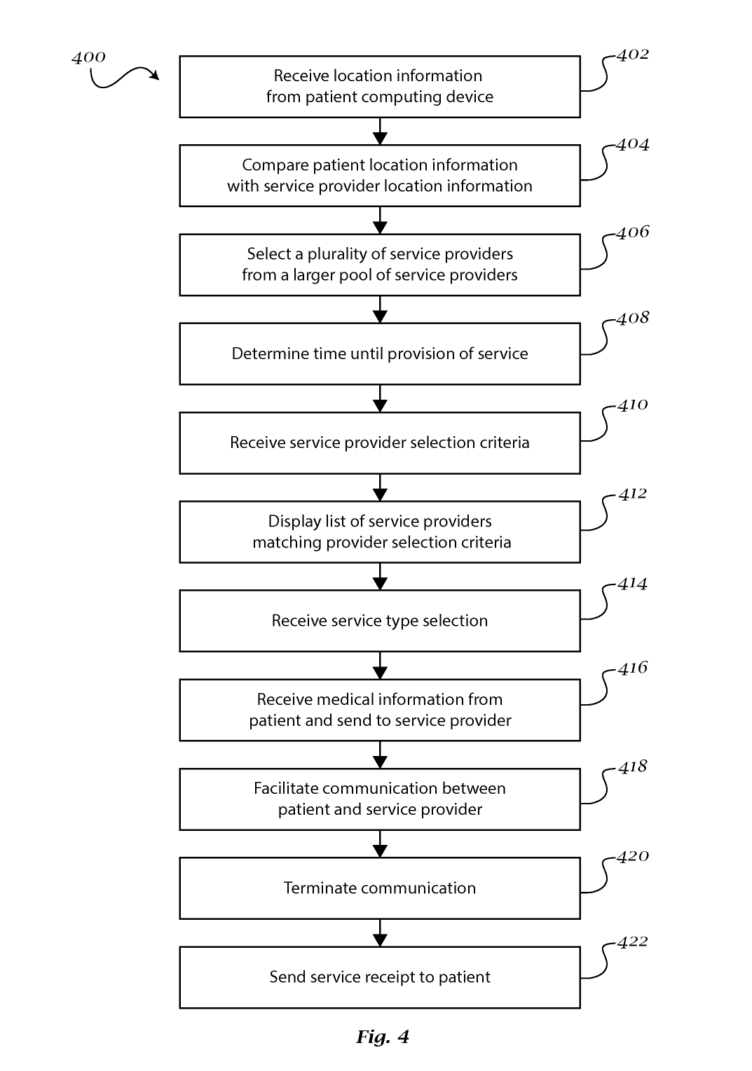

FIG. 3 shows an exemplary embodiment of a method 300 for registering a service provider account and creating a service provider profile. This may be accomplished, for example, via a user interface provided by service application 152. At step 302, a service provider account may be created. The service provider may create an account by, for example, registering a user name and password. The user name may be one or more of an email, telephone number, or other information unique to the service provider. The password may be created in conjunction with the user name, and provide access the service provider account. Once registered, a service provider may sign into the system using the user name and password.

Subsequently, at step 304, service provider information may be received and associated with the service provider account created at step 302. The service provider information may include information particular to the service provider, such as the service provider's first name, last name, and gender. The service provider information may further include such information such as the service provider's business name, the service provider's specialty, the service provider's office location, contact information for the service provider, for example telephone number and email address, and any other relevant information as would be understood by a person of ordinary skill in the art. Additional information pertaining to the service provider may also be received. Such additional information may include, for example, the service provider's curriculum vitae, which may include the educational institutions attended by the service provider, the degrees received by the service provider, and current and past employment information of the service provider. The additional service provider information may further include a personal photograph, which may be obtained via a camera of the computing device, or by uploading an existing photograph, for example, from the memory of the computing device.

At step 306, the service provider's payment information may be received. Such payment information may include the types of insurance plans accepted by the service provider, and details of one or more financial institution accounts where the service provider would like to receive payment. At step 308, the service provider may be granted access to the system and the methods for providing on-demand medical services described herein.

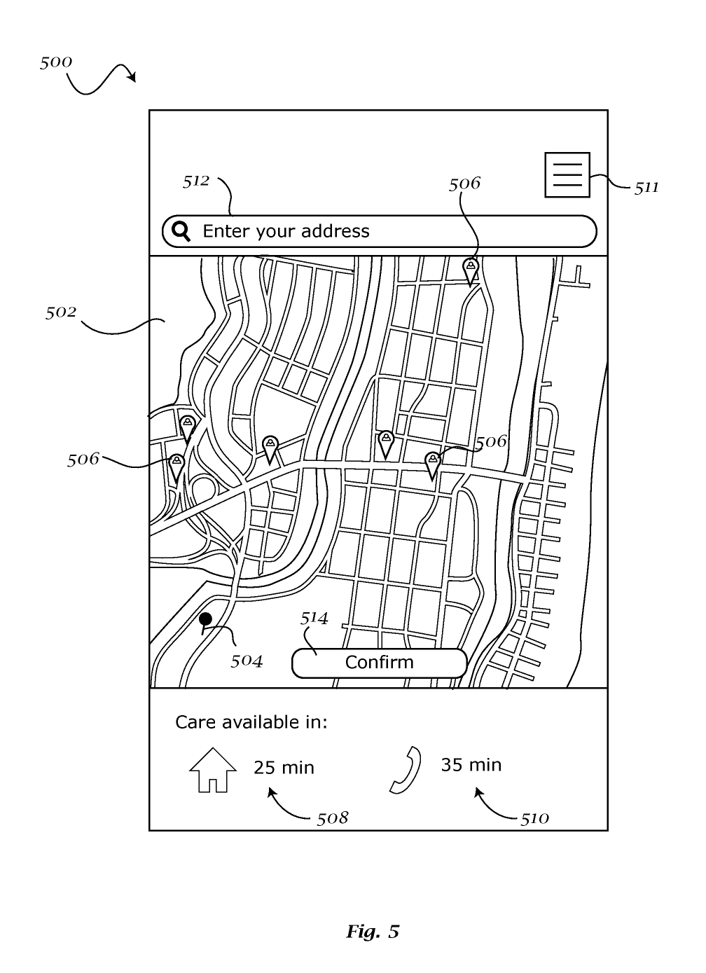

FIG. 4 illustrates an exemplary embodiment of a method 400 for enabling on-demand medical treatment or consultation to be arranged between a patient user and a service provider user. In some embodiments, at step 402, location information may be received from a patient user's computing device. In some embodiments, a user may provide their geographical location in a user interface such as illustrated in FIG. 5. In other exemplary embodiments, the computing device may include or access automatic geographic location services, such as global positioning systems, network-based location services, Wi-Fi positioning systems, SIM-based location, or any other positioning technology known in the art that can automatically provide geographic location information to system 150.

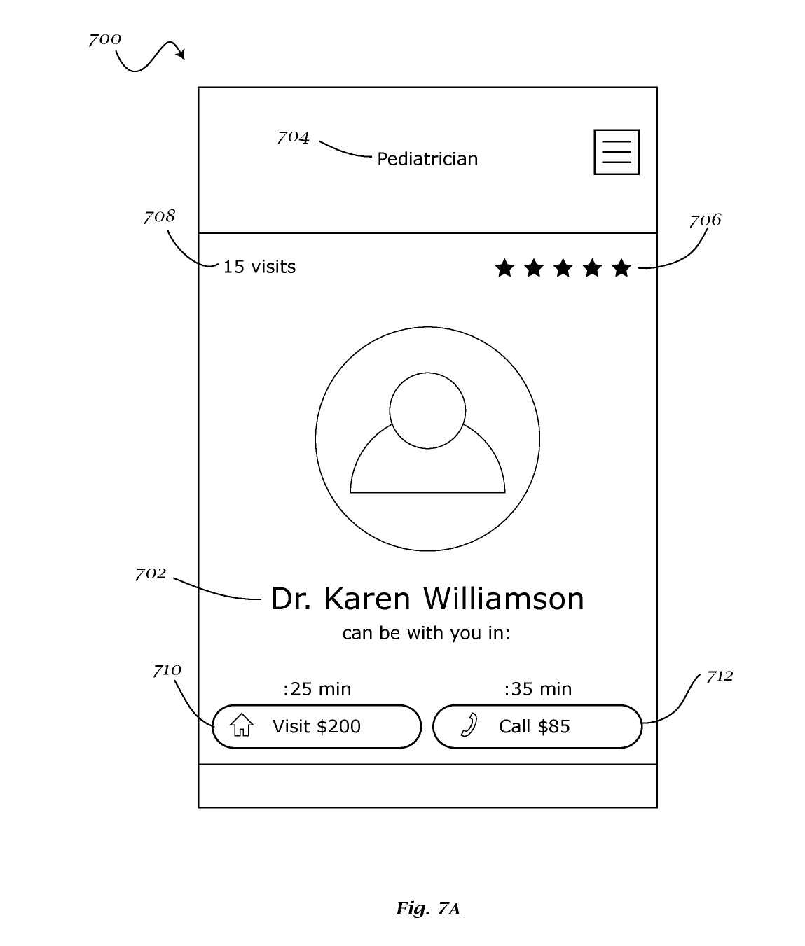

At step 404, received patient location information may be compared with service provider location information. The service providers may be similarly equipped with a computing device that can provide their respective geographic location to system 150, and service provider location information may be received in a manner similar to that described in step 402. At step 406, a plurality of potential service providers from a larger pool of service providers may be selected. The pool of service providers may include the service providers that have registered an account and created a service provider profile with system 150. The plurality of potential service providers may be selected from the larger pool based on the geographical proximity of the patient's computing device to the locations of the service providers. For example, a plurality of potential service providers within a certain distance range of the patient, or within a certain traveling time range of the patient, may be selected. At step 408, service provision time may be determined. The service provision time may be determined for each service offered by the service provider. The determination may be accomplished by system 150 with regard to a plurality of criteria, for example, but not limited to, service type, distance from service provider to client, the number of queued services to be provided by the service provider prior to servicing the patient, and so forth. The selected plurality of service providers and the corresponding service provision times may then be displayed to the patient user via an interface such as the one illustrated in FIG. 6.

At step 410, service provider selection criteria may be received. The selection criteria may include one or more of specialty, availability, wait time, cost, reputation, quality of service, name recognition, curriculum vitae, or any other criteria as would be understood by a person of ordinary skill in the art. At step 412, a list of service providers from the plurality of service providers selected in step 404 and matching the criteria received in step 406 may be caused to be displayed on the patient's computing device.

At step 414, a service type selection may be received from the patient. For example, the patient may choose to speak with the service provider remotely, for example via telephone or via a computing device. Alternatively, the patient may also choose for the service provider to make a visit to the patient's location. The various services and associated service costs may be displayed via an interface on the patient's computing device; service selection may also be facilitated via the interface.

At step 416, current medical information may be received from the patient and sent to the service provider. Current medical information may include such information as the patient's symptoms, the patient's vitals, and any other desired information regarding the patient's health state. Medical information may be entered by the patient via an interface on the patient's computing device. In some embodiments, certain patient vital information may be received from a health monitoring device communicatively coupled to the patient's computing device.

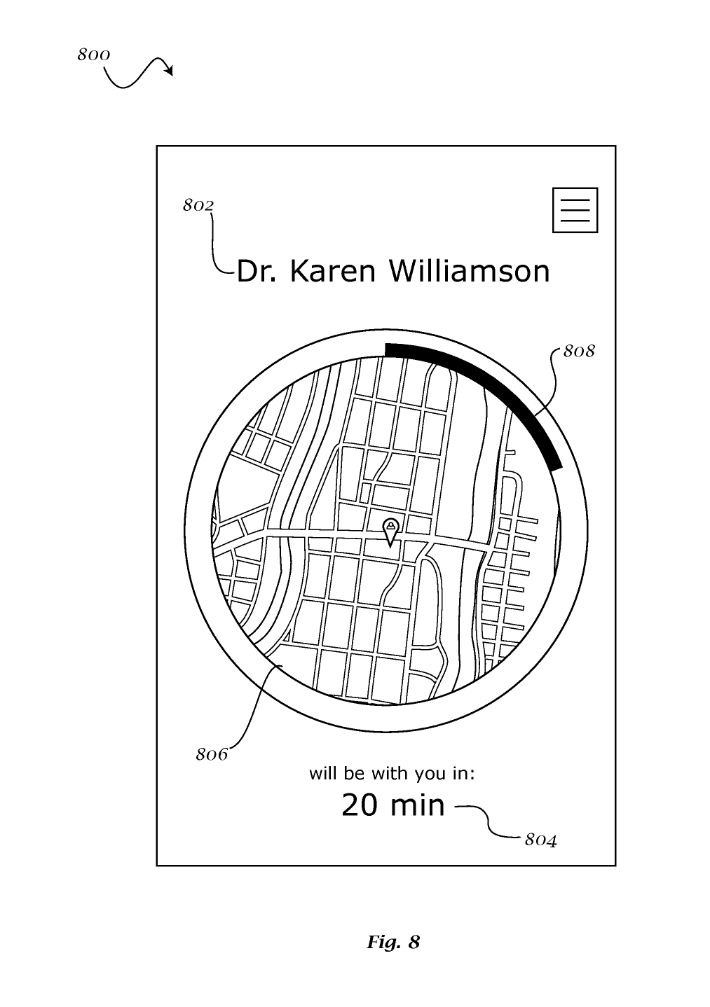

At step 418, connection between the patient and the service provider may be facilitated. The connection may be facilitated differently based on the services selected in step 410. For example, if a patient selected to speak to the service provider, connection may be facilitated by providing a voice or video link between the patient and service provider. The voice or video link may be executed, for example, via the internet and within the interface provided by system 150 on the user's and service provider's mobile devices, via the internet and via another interface, via cellular or land phone lines, or via any other manner known in the art. Alternatively, if the patient chose for the service provider to visit the patient's location, connection may be facilitated by notifying the selected service provider of the visit request, and subsequently providing live information to the patient regarding the upcoming appointment. The live information may be provided on the patient computing device, for example via an interface, via push communications, and so forth. Such information may include, for example, live wait time, delay time, progress communications, location of the selected service provider, or other information as would be understood by a person of ordinary skill in the art. Such information may be provided via a user interface such as the one illustrated in FIG. 8.

At step 420, connection between the patient and the service provider may be terminated. For example, if the patient chose communication via voice or video link, the link may be terminated. Alternatively, if the patient chooses a service provider visit, the provision of live information may be terminated once it is determined by system 150 that the service provider has arrived at the patient's location. Such a determination may be made, for example, via receipt of a confirmation sent by one or more of the patient and the service provider that the service provider has arrived at the patient's location. Subsequently, the scheduled appointment and services may be executed. After the appointment has concluded, a receipt for the provided services may be sent, at step 422, to the patient. The patient may also have the option to comment on the visit and leave a rating for the service provider. Comments and ratings may be stored by system 150 in association with the particular service provider. Funds may be transferred from the patient to the service provider, via system 150, at any desired point between step 414 and step 422.

In alternative exemplary embodiments, a method for enabling on-demand medical treatment or consultation to be arranged between a patient user and a service provider user at a service provider location may be provided. The patient may elect to visit the service provider, for example, at a service provider's location, care facility, doctor's office, or other location as would be understood by a person of ordinary skill in the art. Once the patient chooses the location of the service provider, live information may be provided on the patient computing device, for example via an interface, via push communications, and so forth. Such information may include, for example, live wait time, delay time, progress communications, or other information as would be understood by a person of ordinary skill in the art. As a result a patient may, for example, limit or avoid extended wait times in a waiting room of a care facility. Still further, patient location information may be provided to a service provider interface which may show updated progress of a patient in route to the service provider location.

FIG. 5 shows a primary user interface 500. Primary user interface 500 may include an expanded map 502 which may provide information about the location of the user 504 marked by a geographic pin as well as one or more graphic representations of potential service providers 506. The geographic location of the potential service providers are dynamically provided on expanded map 502 to indicate the current location of the available service providers. Primary user interface 500 may include dynamic information regarding the earliest possible home visit 508 and earliest possible telephone consultation 510. Primary user interface may further have a menu link 511, which may display links to, for example, the user account, user profile, payment information, promotional information, or other like links as would be understood by a person of ordinary skill.

Primary user interface may have an address entry bar 512 which may permit the patient to enter an address for the appointment. Alternatively, if the address of the appointment is the same as the location of the user 504, the user may confirm this address using confirm button 514. Once a user either enters an address in address entry bar 512 or confirms the current user location using confirm button 514, a user may be provided with a list of potential service providers in a user interface such as illustrated in FIG. 6 as next discussed.

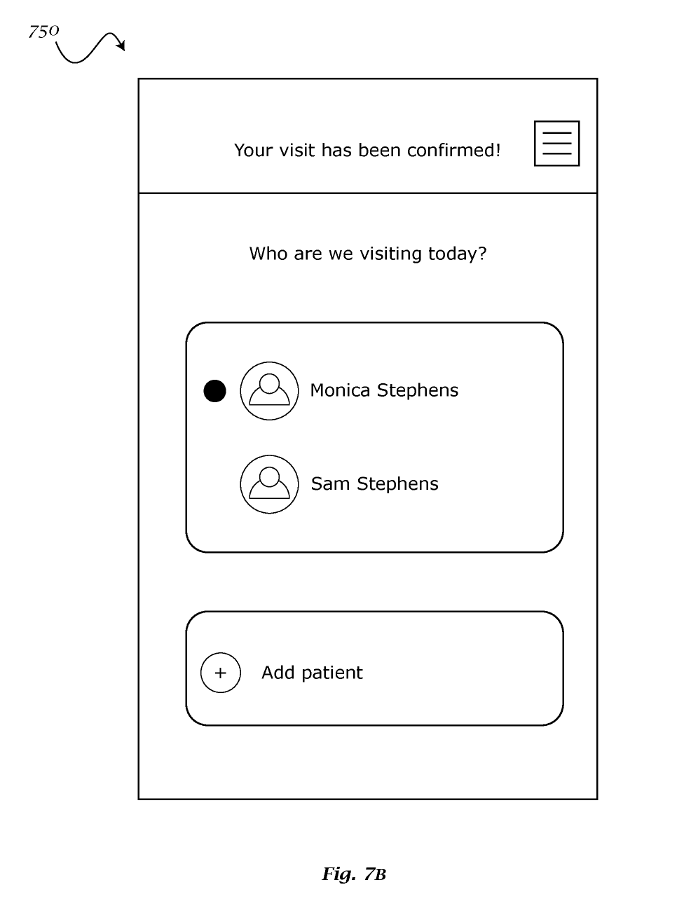

FIG. 6 may show a user interface 600 displaying a plurality of potential service providers 602. The plurality of available potential service providers 602 may be selected from a larger pool of service providers based on relative proximity to the entered or confirmed address for the user appointment. Each potential service provider 602 displayed on user interface 600 may include a picture of the service provider 604, a specialty 606, a rating 608, and current wait times for a home visit 610 and a telephone consultation 612. User interface 600 may permit the user to sort the plurality of available potential service providers by applying one or more filters 614. A user may select a potential service provider 602 and be provided with a confirmation interface such as illustrated in FIGS. 7a-7b as next discussed.

FIG. 7a shows a confirmation interface 700 displaying a selected service provider. Confirmation interface may include a photo of the selected service provider, the service provider's name 702, specialty 704, rating 706, and previous appointments 708. Confirmation interface 700 may also include one or more of a house visit button 710, and a telephone button 712. A price and approximate wait time may be associated with each of the house visit button 710, and the telephone button 712. If a user wishes to schedule an appointment, they may select either the home visit button 710 or the telephone button 712. Upon selecting either the home visit button 710 or telephone button 712, a user may be asked to confirm the selected visit, via, for example, a confirmation block or another user interface element. Upon confirmation of the visit, the user may be asked to verify an individual subject for the appointment via patient selection interface 750 as shown in FIG. 7b, if more than one user profile is associated with the user account.

Upon confirmation of the appointment, a user may be requested to submit information in advance of the appointment. For example, the user may be requested to supply information related to symptoms, vitals, medical history, payment and insurance information, or other information as would be understood to a person of ordinary skill in the art. The user may provide this information manually, or from stored information in one or more of the user account, user profile, or payment information.

Subsequent to confirmation, and prior to arrival of the service provider, a live monitoring interface 800 may be displayed, as shown in FIG. 8. Live monitoring interface 800 may include the name of the service provider 802, a time to visit clock 804, service provider location map 806, and an analog timer 808 displaying remaining time until service provider arrival. Monitoring interface 800 may also display notifications regarding the progress of the service provider, for example notifications that a delay has occurred or that the appointment has been cancelled.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A computer-implemented method for coordinating on-demand medical services, comprising executing on one or more processors the steps of:
determining, from a pool of service providers, a plurality of service providers within a geographical proximity of a patient;
determining service provision time for one or more service types, for each service provider of the plurality of service providers;
causing to be displayed, on a computing device of the patient, the plurality of service providers, one or more service types for each service provider, and service provision times for each service type;
receiving a service provider selection and a service type selection from the patient; and
facilitating a connection between the patient and the selected service provider wherein facilitating a connection comprises providing live information, to the patient, regarding a visit of the service provider to the location of the patient.

2. The method of claim 1, wherein facilitating a connection comprises providing a voice or video link between the patient and service provider.

3. (canceled)

4. The method of claim 1, wherein the live information comprises one or more of wait time, delay time, progress communications, and location of the selected service provider.

5. The method of claim 1, wherein the one or more service types comprises one or more of a distance communication between the patient and the service provider, and a visit by the service provider to the location of the patient.

6. The method of claim 1, further comprising causing to be displayed, on the computing device of the patient, a narrowed selection of service providers, based on criteria including one or more of specialty, availability, wait time, cost, reputation, quality of service, name recognition, and curriculum vitae.

7. The method of claim 1, further comprising:
receiving, from the patient, one or more of current medical information, medical history insurance plan information, employment information, emergency contacts, medications, allergies, immunizations, lifestyle, medical tests, and surgeries; and
sending, to the service provider, one or more of the current medical information, medical history insurance plan information, employment information, emergency contacts, medications, allergies, immunizations, lifestyle, medical tests, and surgeries.

8. A non-transitory computer readable medium storing a set of computer readable instructions that, when executed by one or more processors, causes a computing device of a patient to perform the steps of:
sending a geographical location of the computing device;
displaying, on a display of the computing device, a plurality of service providers within geographical proximity to the location of the computing device, one or more service types for each service provider, and service provision times for each service type;
sending a service provider selection and a service type selection; and
displaying, on the display of the computing device, a live monitoring interface, the live monitoring interface including one or more of wait time, delay time, progress communications, and location of the selected service provider.

9. The computer readable medium of claim 8, further comprising causing the computing device to perform the step of displaying, on the display of the computing device, a narrowed selection of service providers, based on criteria including one or more of specialty, availability, wait time, cost, reputation, quality of service, name recognition, and curriculum vitae.

10. The computer readable medium of claim 8, further comprising causing the computing device to perform the step of sending one or more of current medical information of the patient and medical history of the patient.

11. The computer readable medium of claim 10, wherein the current medical information is input by the patient on the computing device.

12. The computer readable medium of claim 10, wherein the current medical information is received from a health monitoring device communicatively coupled to the computing device.

13. The computer readable medium of claim 8, further comprising causing the computing device to perform the step of displaying, on the display of the computing device, a selection of one or more patients to whom a service is to be provided.

14. A non-transitory computer readable medium storing a set of computer readable instructions that, when executed by one or more processors, performs the steps of:
determining, from a pool of service providers, a plurality of service providers within a geographical proximity of a patient;
determining service provision time for one or more service types, for each service provider of the plurality of service providers;
causing to be displayed, on a computing device of the patient, the plurality of service providers, one or more service types for each service provider, and service provision times for each service type;
receiving a service provider selection and a service type selection from the patient; and
facilitating a connection between the patient and the selected service provider wherein facilitating a connection comprises providing live information, to the patient, regarding a visit of the service provider to the location of the patient.

15. The computer readable medium of claim 14, wherein facilitating a connection comprises providing a voice or video link between the patient and service provider.

16. (canceled)

17. The computer readable medium of claim 14, wherein the live information comprises one or more of wait time, delay time, progress communications, and location of the selected service provider.

18. The computer readable medium of claim 14, wherein the one or more service types comprises one or more of a distance communication between the patient and the service provider, and a visit by the service provider to the location of the patient.

19. The computer readable medium of claim 14, further comprising causing to be displayed, on the computing device of the patient, a narrowed selection of service providers, based on criteria including one or more of specialty, availability, wait time, cost, reputation, quality of service, name recognition, and curriculum vitae.

20. The computer readable medium of claim 14, further comprising performing the steps of:
receiving, from the patient, one or more of current medical information, medical history insurance plan information, employment information, emergency contacts, medications, allergies, immunizations, lifestyle, medical tests, and surgeries; and
sending, to the service provider, one or more of the current medical information, medical history insurance plan information, employment information, emergency contacts, medications, allergies, immunizations, lifestyle, medical tests, and surgeries.
